(19) United States
(12) Patent Application Publication
(10) Pub. No.: US 2006/0026214 A1
(43) Pub. Date: Feb. 2, 2006

(54) Switching from synchronous to asynchronous processing

(75) Inventors: Douglas Charles Berg, Rochester, MN (US); A. Joseph Bockhold, Rochester, MN (US); Charles James Redlin, Rochester, MN (US); Hao Wang, Rochester, MN (US); Robert Eugene Westland, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/901,599

(22) Filed: Jul. 29, 2004

(51) Int. Cl. G06F 17/30

(52) U.S. Cl. 707/201

(57) ABSTRACT

A method, apparatus, system, and signal-bearing medium that, in an embodiment, switch between synchronous processing and asynchronous processing for a request if the synchronous processing for the request is unsuccessful and send a synchronous response to a client that initiated the request after the asynchronous processing of the request. In an embodiment, an asynchronous response for the asynchronous processing is sent to a bridge, which then sends the synchronous response to the client. In this way, the client may receive a synchronous response even if the request is performed by asynchronous processing.

### FIELD

An embodiment of the invention generally relates to computers. In particular, an embodiment of the invention generally relates to switching from synchronous to asynchronous processing.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware (such as semiconductors, integrated circuits, programmable logic devices, programmable gate arrays, and circuit boards) and software, also known as computer programs.

Years ago, computers were isolated devices that did not communicate with each other. But, today computers are often connected in networks, such as the Internet or World Wide Web, and a user at one computer, often called a client, may wish to access information at multiple other computers, often called servers, via a network. Accessing and using information from multiple computers is often called distributed computing.

One of the challenges of distributed computing is handling multiple requests from multiple clients across multiple communications channels. A channel represents an open connection to an entity, such as a hardware device, a file, a network socket, or a program component that is capable of performing one or more distinct I/O operations, such as reading or writing data. Requests can be implemented using either synchronous or asynchronous processing. In synchronous processing, each request or communications connection is assigned its own programming thread. A programming thread (a process or a part of a process) is a programming unit that is scheduled for execution on a processor and to which resources such as execution time, locks, and queues may be assigned. Synchronous processing typically has faster response times and works well for smaller numbers of concurrently open connections or requests than does asynchronous processing.

In asynchronous processing, all communications connections or requests share the same programming thread or the same set of threads. Asynchronous processing does not perform as well as synchronous processing for small numbers of concurrent connections or requests, but asynchronous processing does have the advantage that it scales well to large numbers of concurrent connections or requests because asynchronous processing does not associate a thread with each concurrent connection. Instead, in asynchronous processing, the available thread(s) are shared between the concurrent connections or requests, which reduces overhead since each additional thread has an associated overhead. Asynchronous processing also provides better server utilization (efficiency) than does synchronous processing because in asynchronous processing, the server processes requests at the best time for the server. Thus, asynchronous processing scales to much larger numbers of concurrent connections or requests and provides better server utilization, but trades off response time to gain these advantages.

From a user's perspective, synchronous and asynchronous processing can appear quite different. For example, in synchronous processing when placing a product order via an online server, the server processes the order (the request) and returns a result, such as a confirmation or order status, immediately or nearly immediately, typically across the same connection that initiated the request. In contrast, in asynchronous processing, the online server processes the orders at a later time and sends the confirmation or order status to the user's email address, which is typically a different connection from that which initiated the request. The user must wait after submitting the order to later log into the email to check the status of the order. Thus, users prefer the convenience of synchronous processing while administrators of servers prefer asynchronous processing when handling large numbers of concurrent requests.

Thus, without a better way to process multiple concurrent requests, either synchronous response time or server utilization must be sacrificed, both of which are undesirable.

### SUMMARY

A method, apparatus, system, and signal-bearing medium are provided that, in an embodiment, switch between synchronous processing and asynchronous processing for a request if the synchronous processing for the request is unsuccessful and send a synchronous response to a client that initiated the request after the asynchronous processing of the request. In an embodiment, an asynchronous response for the asynchronous processing is sent to a bridge, which then sends the synchronous response to the client. In this way, the client may receive a synchronous response even if the request is performed by asynchronous processing.

### BRIEF DESCRIPTION OF THE DRAWING

FIG. 1 depicts a block diagram of an example system for implementing an embodiment of the invention.

FIG. 2 depicts a block diagram of an example cluster of servers, according to an embodiment of the invention.

FIG. 3 depicts a flowchart of example processing for handling a request from a client, according to an embodiment of the invention.

FIG. 4 depicts a flowchart of example processing for switching from a synchronous request to an asynchronous request, according to an embodiment of the invention.

### DETAILED DESCRIPTION

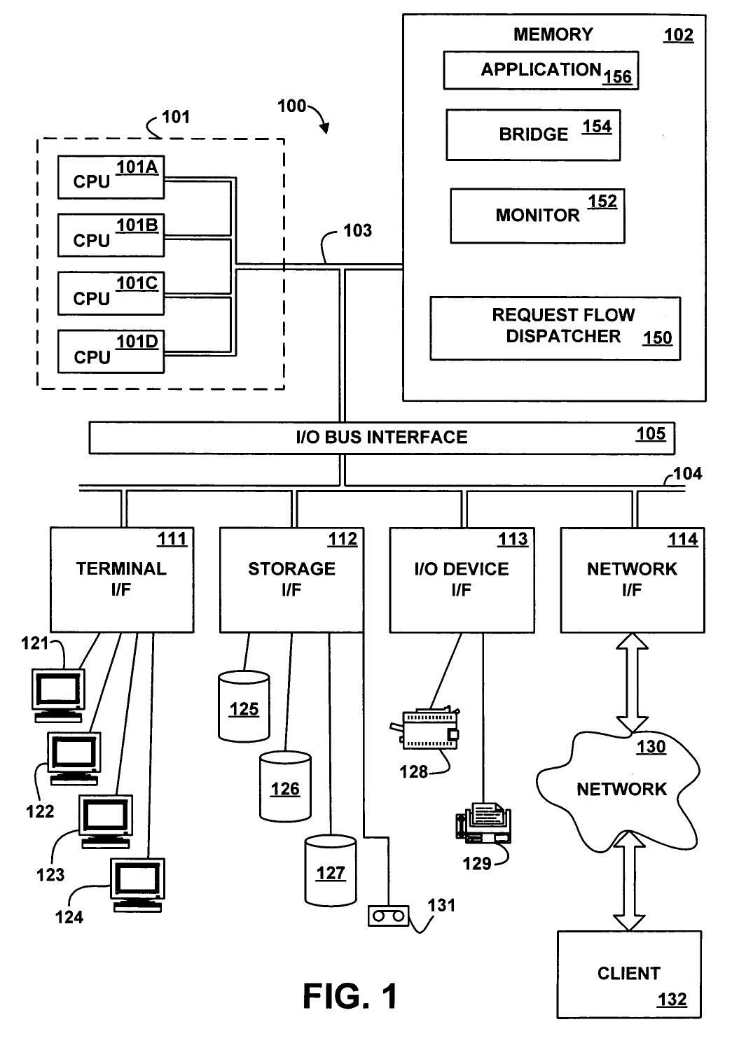

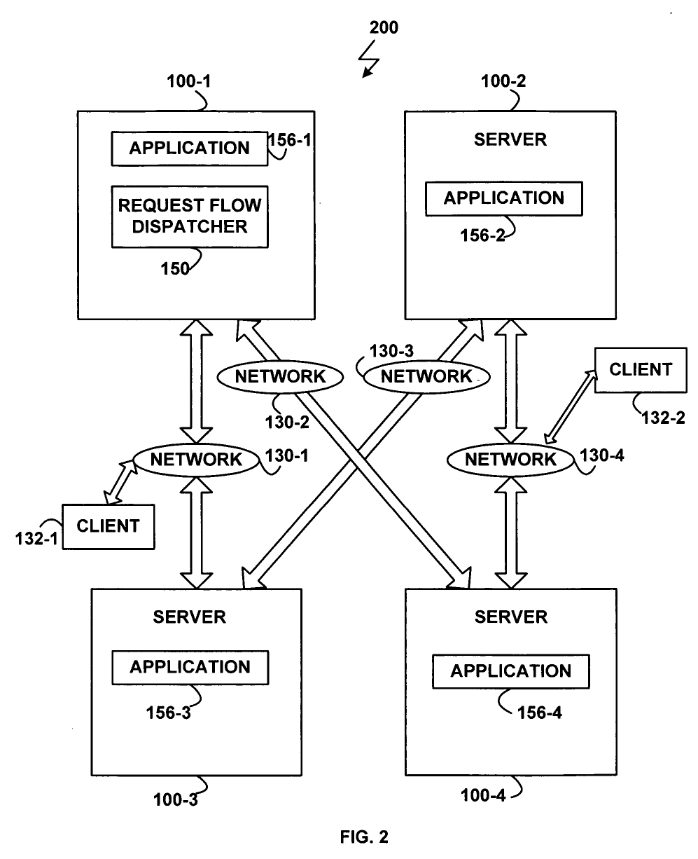

Referring to the Drawing, wherein like numbers denote like parts throughout the several views, FIG. 1 depicts a high-level block diagram representation of a computer system 100 connected to a client or clients 132 via a network 130, according to an embodiment of the present invention. The computer system 100 acts as a server to the clients 132, and multiple of the computer systems 100 may be configured in a cluster, as further described below with reference to FIG. 2.

The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures.

The memory 102 includes a request flow dispatcher 150, a monitor 152, a bridge 154, and an application 156. Although the request flow dispatcher 150, the monitor 152, the bridge 154, and the application 156 are all illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the request flow dispatcher 150, the monitor 152, the bridge 154, and the application 156 are all illustrated as residing in the memory 102, these elements are not necessarily all completely contained in the same storage device at the same time.

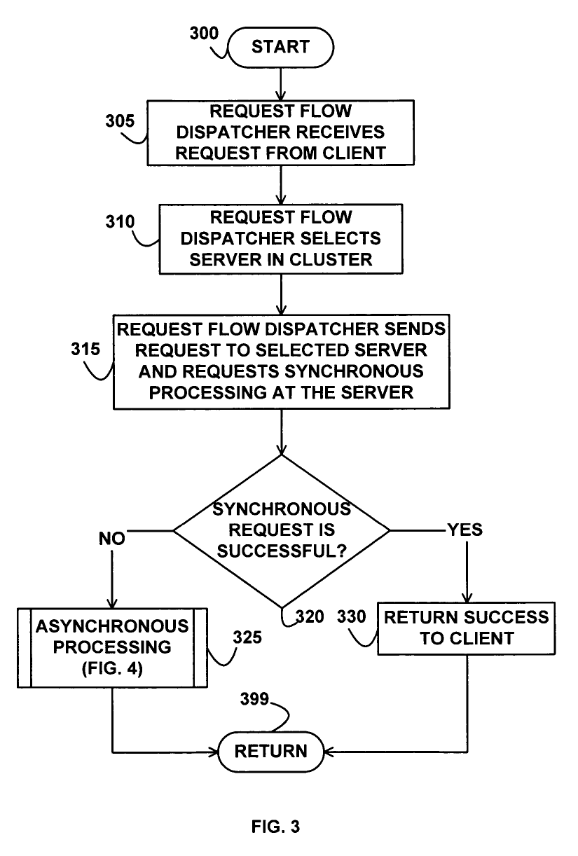

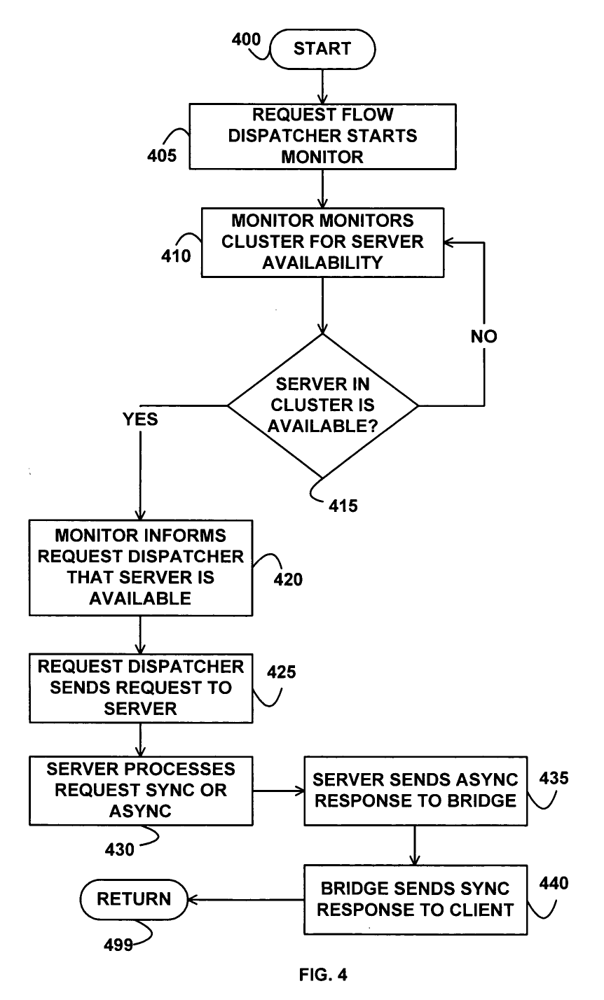

The request flow dispatcher 150 receives and processes requests from the clients 132 to open and close connections and perform I/O requests, such as reads and writes of data to/from the clients 132. The request flow dispatcher 150 further allocates the connections and data transfer requests among the applications 156 across various of the computer systems 100, using either synchronous processing or asynchronous processing. In an embodiment, the request flow dispatcher 150, the monitor 152, and the bridge 154 include instructions capable of executing on the processor 101 or statements capable of being interpreted by instructions executing on the processor 101 to perform the functions as further described below with reference to FIGS. 3, and 4. In another embodiment, the request flow dispatcher 150, the monitor 152, and/or the bridge 154 may be implemented in microcode. In yet another embodiment, the request flow dispatcher 150, the monitor 152, and/or the bridge 154 may be implemented in hardware via logic gates and/or other appropriate hardware techniques, in lieu of or in addition to a processor-based system.

The monitor 152 monitors for availability of servers in a cluster, as further described below with reference to FIG. 2. The bridge 154 receives asynchronous responses from the application 156 and sends synchronous responses to the clients 132, as further described below with reference to FIG. 4. The application 156 processes requests from the clients 132.

The memory bus 103 provides a data communication path for transferring data among the processors 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interconnect) bus, or any other appropriate bus technology. The I/O interface units support communication with a variety of storage and I/O devices. For example, the terminal interface unit 111 supports the attachment of one or more user terminals 121, 122, 123, and 124.

The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the DASD 125, 126, and 127 may be loaded from and stored to the memory 102 as needed. The storage interface unit 112 may also support other types of devices, such as a tape device 131, an optical device, or any other type of storage device.

The I/O and other device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3× specification. In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

The client 132 requests the request flow dispatcher 150 to open and close connections to the computer system 100 and send requests to the application 156. The client 132 may include some or all of the hardware components previously described above for the computer system 100. Although only one client 132 is illustrated, in other embodiments any number of clients may be present.

It should be understood that FIG. 1 is intended to depict the representative major components of the computer system 100 and the client 132 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements embodying the various aspects of an embodiment of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of signal-bearing media, which include, but are not limited to:
(1) information permanently stored on a non-rewriteable storage medium, e.g., a read-only memory device attached to or within a computer system, such as a CD-ROM readable by a CD-ROM drive;
(2) alterable information stored on a rewriteable storage medium, e.g., a hard disk drive (e.g., DASD 125, 126, or 127) or diskette; or
(3) information conveyed to the computer system 100 by a communications medium, such as through a computer or a telephone network, e.g., the network 130, including wireless communications.

Such signal-bearing media, when carrying machine-readable instructions that direct the functions of the present invention, represent embodiments of the present invention.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a block diagram of an example configuration of a cluster 200 of servers 100-1, 100-2, 100-3, and 100-4, connected by various networks 130-1, 130-2, and 130-3, and 130-4. The networks 130-1, 130-2, 130-3, and 130-4 are referred to generically in FIG. 1 as the network 130. Although the networks 130-1, 130-2, 130-3, and 103-4 are illustrated as being separate, in another embodiment some or all of them may be the same network. The servers 100-1, 100-2, 100-3, and 100-4 are referred to generically in FIG. 1 as the computer system 100.

The server 100-1 includes the request flow dispatcher 150, but in other embodiments the request flow dispatcher 150 may be distributed across other, some, or all of the servers 100-1, 100-2, 100-3, and 100-4. Each of the servers 100-1, 100-2, 100-3, and 100-4 includes a instance of the application 156, which are identified as 156-1, 156-2, 156-3, and 156-4, respectively. The request flow dispatcher 150 distributes requests from the clients 131-1 and 132-2 across the servers 100-1, 100-2, 100-3, and 100-4 to the respective applications 156-1, 156-2, 156-3, and 156-4.

The clients 132-1 and 132-2 (instances of the client 132) are shown connected to the networks 130-1 and 130-4, respectively, but in other embodiments, the clients 132 may be connected to any, some, or all of the networks 130, and any number of the servers 100, the networks 130, and the clients 132 may be present in any appropriate configuration.

FIG. 3 depicts a flowchart of example processing for handling a request from one of the clients 132, according to an embodiment of the invention. Control begins at block 300. Control then continues to block 305 where the request flow dispatcher 150 receives a request from the client 132. Control then continues to block 310 where the request flow dispatcher 150 selects one of the servers from the cluster 200, such as the server 100-1, 100-2, 100-3, or 100-4, as previously described above with reference to FIG. 2.

Control then continues to block 315 where the request flow dispatcher 150 sends the received request to the selected server 100 and directs the target application 156 at the selected server 100 to process the request using synchronous processing. Control then continues to block 320 where the request flow dispatcher 150 determines whether the application 156 performed the request synchronously. If the determination at block 320 is true, then the application 156 performed the request synchronously, so control continues to block 330 where the request flow dispatcher 150 returns a success report in a synchronous manner to the client 132, e.g., on the same connection that initiated the request. Control then continues to block 399 where the logic of FIG. 3 returns.

If the determination at block 320 is false, then the application 156 was not able to perform the request synchronously, so control continues to block 325 where asynchronous processing is performed, as further described below with reference to FIG. 4. In various embodiments, the application 156 may be unable to perform synchronous processing because the server 100 is unavailable, is dedicated to asynchronous processing, or is too heavily loaded to perform synchronous processing at this time. Control then continues to block 399 where the logic of FIG. 3 returns.

FIG. 4 depicts a flowchart of example processing for handling switching from synchronous processing to asynchronous processing, according to an embodiment of the invention. Control begins at block 400. Control then continues to block 405 where the request flow dispatcher 150 starts the monitor 152. Control then continues to block 410 where the monitor 152 monitors the cluster 200 for availability of one of the servers 100-1, 100-2, 100-3, and 100-4. Control then continues to block 415 where the monitor 152 determines whether a server 100 in the cluster 200 is available.

If the determination at block 415 is true, then one of the servers 100 in the cluster 200 is available, so control continues to block 420 where the monitor 152 informs the request flow dispatcher 150 that one of the servers 100 is available. Control then continues to block 425 where the request flow dispatcher 150 sends the request to the server 100, which was previously determined to be available. Control then continues to block 430 where the application 156 at the selected server 100 processes the request in a synchronous manner if possible, and if not possible the application 156 processes the request in an asynchronous manner.

Control then continues to block 435 where the application 156 at the selected server 100 sends an asynchronous response to the bridge 154. Control then continues to block 440 where the bridge 154 sends a synchronous response to the client 132, which initiated the original request, e.g., on the same connection across which the client 132 initiated the request. Control then continues to block 499 where the logic of FIG. 4 returns.

If the determination at block 415 is false, then one of the servers 100 in the cluster 200 is not available, so control returns to block 410, as previously described above.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of embodiments of the invention. But, embodiments of the invention may be practiced without these specific details. In other instances, well-known circuits, structures, and techniques have not been shown in detail in order not to obscure the invention.

What is claimed is:

1. A method comprising:
switching between synchronous processing and asynchronous processing for a request if the synchronous processing for the request is unsuccessful.

2. The method of claim 1, further comprising:
sending a synchronous response to a client that initiated the request after the asynchronous processing of the request.

3. The method of claim 1, further comprising:
monitoring for availability of a server in a cluster after the synchronous processing is unsuccessful.

4. The method of claim 3, further comprising:
sending the request to the server for the asynchronous processing if the server is available.

5. An apparatus, comprising:
means for switching between synchronous processing and asynchronous processing for a request if the synchronous processing for the request is unsuccessful; and
means for sending a synchronous response to a client that initiated the request after the asynchronous processing of the request.

6. The apparatus of claim 5, further comprising:
means for monitoring for availability of a server in a cluster after the synchronous processing is unsuccessful.

7. The apparatus of claim 6, further comprising:
means for sending the request to the server for the asynchronous processing if the server is available.

8. The apparatus of claim 5, wherein the synchronous processing is unsuccessful if a server that receives the request is too heavily loaded to perform the synchronous processing.

9. A signal-bearing medium encoded with instructions, wherein the instructions when executed comprise:
switching between synchronous processing and asynchronous processing for a request if the synchronous processing for the request is unsuccessful;
sending an asynchronous response to a bridge; and
sending synchronous response from the bridge to a client that initiated the request after the asynchronous processing of the request.

10. The signal-bearing medium of claim 9, further comprising:
monitoring for availability of a server in a cluster after the synchronous processing is unsuccessful.

11. The signal-bearing medium of claim 10, further comprising:
sending the request to the server for the asynchronous processing if the server is available.

12. The signal-bearing medium of claim 9, wherein the synchronous processing is unsuccessful if a server that receives the request is too heavily loaded to perform the synchronous processing.

13. A computer system comprising:
a processor; and
memory encoded with instructions, wherein the instructions when executed on the processor comprise:
switching between synchronous processing and asynchronous processing for a request if the synchronous processing for the request is unsuccessful,
monitoring for availability of a server in a cluster after the synchronous processing is unsuccessful,
sending an asynchronous response to a bridge, and
sending synchronous response from the bridge to a client that initiated the request after the asynchronous processing of the request.

14. The computer system of claim 13, wherein the instructions further comprise:
sending the request to the server for the asynchronous processing if the server is available.

15. The computer system of claim 13, wherein the synchronous processing is unsuccessful if the server that receives the request is too heavily loaded to perform the synchronous processing.

16. The computer system of claim 13, wherein the synchronous processing is unsuccessful if the server that receives the request is not currently performing the synchronous processing.

17. A method for configuring a computer, comprising:
configuring the computer to switch between synchronous processing and asynchronous processing for a request if the synchronous processing for the request is unsuccessful.

18. The method of claim 17, further comprising:
configuring the computer to send a synchronous response to a client that initiated the request after the asynchronous processing of the request.

19. The method of claim 17, further comprising:
configuring the computer to monitor for availability of a server in a cluster after the synchronous processing is unsuccessful.

20. The method of claim 19, further comprising:
configuring the computer to send the request to the server for the asynchronous processing if the server is available.
